(19) United States
(12) Patent Application Publication
(10) Pub. No.: US 2014/0298394 A1
(43) Pub. Date: Oct. 2, 2014

(54) IMAGE PROCESSING DEVICE, IMAGE PROCESSING METHOD, AND COMPUTER PROGRAM

(71) Applicant: Sony Corporation, Tokyo (JP)

(72) Inventor: Kuniaki Kurihara, Tokyo (JP)

(73) Assignee: SONY CORPORATION, Tokyo (JP)

(21) Appl. No.: 14/211,062

(22) Filed: Mar. 14, 2014

(30) Foreign Application Priority Data
Mar. 26, 2013 (JP) 2013-064016

(51) Int. Cl. H04N 21/442; H04N 21/647; H04N 21/44

(52) U.S. Cl. CPC H04N 21/44209; H04N 21/44016; H04N 21/64738; H04N 21/64769
USPC 725/110

(57) ABSTRACT

There is provided an image processing device including a content acquiring unit configured to simultaneously acquire a plurality of content items distributed through a network, and a bandwidth deciding unit configured to decide a band allocated to each content item acquired by the content acquiring unit, using a ratio for each content item with respect to a bandwidth to be used by all the plurality of content items acquired simultaneously.

### CROSS REFERENCE TO RELATED APPLICATIONS

This application claims the benefit of Japanese Priority Patent Application JP 2013-064016 filed Mar. 26, 2013, the entire contents of which are incorporated herein by reference.

### BACKGROUND

The present disclosure relates to an image processing device, an image processing method, and a computer program.

Since digitization of content and infrastructure that enables transmission of images have been developed, images are more and more commonly distributed through the Internet. In recent years, other than personal computers, more and more television receivers connectable to a network have been made as receiver devices. Thus, it is becoming possible to watch distributed moving image content on television receivers.

JP2000-250505A, for example, discloses a technique that prevents wasteful consumption of a band of a transmission path when moving image content is acquired from a server and displayed on a client terminal such as a personal computer or a television receiver. According to the technique disclosed in JP2000-250505A, a data supplying device provides image data by changing the resolution thereof into a resolution required by a display device, thereby preventing wasteful consumption of the band of the transmission path.

As another example of the related art, there is an adaptive streaming technique on a hypertext transfer protocol (HTTP) basis. Examples of the adaptive streaming technique include an HTTP live streaming technique made by Apple Inc. and an MPEG-Dash technique that is made as a standard by ISO. These techniques include a mechanism that selects and provides the resolution of content and content rate in order to handle variation in bandwidth of a network such as the Internet and diversity of display resolution of the client terminal. According to these techniques, by sending a query about the required moving image content to the server, the client terminal can acquire information in advance about what resolution or bit rate the moving image content to be provided has.

Further, cloud service has been developed in recent years, so that a variety of channels including private content have been provided for viewers through a network. Accordingly, there are more and more needs for a multi-image reproducing system that enables simultaneous viewing of a plurality of moving image content items and easy retrieval of a moving image content item to watch.

### SUMMARY

The technique disclosed in JP2000-250505A does not expect a network environment in which the bandwidth of the transmission path varies. Therefore, the change in the resolution of the moving image content to be reproduced is not sufficient to prevent wasteful consumption of the band effectively.

Further, when a plurality of moving image content items are displayed simultaneously on one screen of a client terminal, bit rates of the acquired content items are decided independently with the existing MPEG-Dash technique. Therefore, all the moving image content items are reproduced at as high bit rates as possible. Accordingly, a bit rate that is higher than necessary can be allocated to a moving image content item that is supposed to be sufficiently displayed at a low bit rate, or a sufficiently high bit rate cannot be allocated to a moving image content item that requires a high bit rate.

Thus, according to one or more of embodiments of the present disclosure, there are provided an image processing device, an image processing method, and a computer program which are novel and improved and can reproduce a plurality of moving image content items effectively without wasteful consumption of a band of a network when the plurality of moving image content items are displayed simultaneously on a screen.

According to an embodiment of the present disclosure, there is provided an image processing device including a content acquiring unit configured to simultaneously acquire a plurality of content items distributed through a network, and a bandwidth deciding unit configured to decide a band allocated to each content item acquired by the content acquiring unit, using a ratio for each content item with respect to a bandwidth to be used by all the plurality of content items acquired simultaneously.

According to another embodiment of the present disclosure, there is provided an image processing method including acquiring a plurality of content items simultaneously, the plurality of content items being distributed through a network, and deciding a bandwidth allocated to each content item acquired in the acquiring step, using a ratio for each content item with respect to a bandwidth to be used by all the plurality of content items acquired simultaneously.

According to another embodiment of the present disclosure, there is provided a computer program causing a computer to execute acquiring a plurality of content items simultaneously, the plurality of content items being distributed through a network, and deciding a bandwidth allocated to each content item acquired in the acquiring step, using a ratio for each content item with respect to a bandwidth to be used by all the plurality of content items acquired simultaneously.

As described above, according to one or more of embodiments of the present disclosure, there can be provided an image processing device, an image processing method, and a computer program which are novel and improved and can reproduce a plurality of moving image content items effectively without wasteful consumption of a band of a network when the plurality of moving image content items are displayed simultaneously on a screen.

### BRIEF DESCRIPTION OF THE DRAWINGS

FIG. 1 shows an overall configuration example of an image processing system 1 according to an embodiment of the present disclosure;

FIG. 2 shows a conceptual diagram of a configuration of a content information list;

FIG. 3 shows an example where a client terminal 100 changes rates and acquires segments;

FIG. 4A shows a process in which a client terminal 100 acquires a plurality of moving image content items using adaptive streaming;

FIG. 4B shows a process in which a client terminal 100 acquires a plurality of moving image content items using adaptive streaming;

FIG. 4C shows a process in which a client terminal 100 acquires a plurality of moving image content items using adaptive streaming;

FIG. 5 shows a function configuration example of a client terminal 100 according to an embodiment of the present disclosure;

FIG. 6A shows a process in which a client terminal 100 acquires a plurality of moving image content items using adaptive streaming;

FIG. 6B shows a process in which a client terminal 100 acquires a plurality of moving image content items using adaptive streaming;

FIG. 6C shows a process in which a client terminal 100 acquires a plurality of moving image content items using adaptive streaming;

FIG. 7 shows an example of decision of a ratio between usable bands of moving image content items;

FIG. 8 shows an example of decision of a ratio between usable bands of moving image content items;

FIG. 9 shows an example of a content acquiring list;

FIG. 10 shows an example of calculation of target rates;

FIG. 11 shows values of target rates and differential rates;

FIG. 12 shows values of target rates and differential rates;

FIG. 13 shows values of target rates and differential rates;

FIG. 14 shows values of target rates and differential rates;

FIG. 15 shows values of target rates and differential rates;

FIG. 16 shows values of target rates and differential rates;

FIG. 17 shows values of target rates and differential rates; and

FIG. 18 shows a function configuration example of a client terminal 100 according to an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be made in the following order.

<1. Embodiment of Present Disclosure>

[Overall Configuration Example]

[Function Configuration Example of Client Terminal]

[Operation Example of Client Terminal]

[Modification Example of Client Terminal]

<2. Conclusion>

### 1. Embodiment of Present Disclosure

### Overall Configuration Example

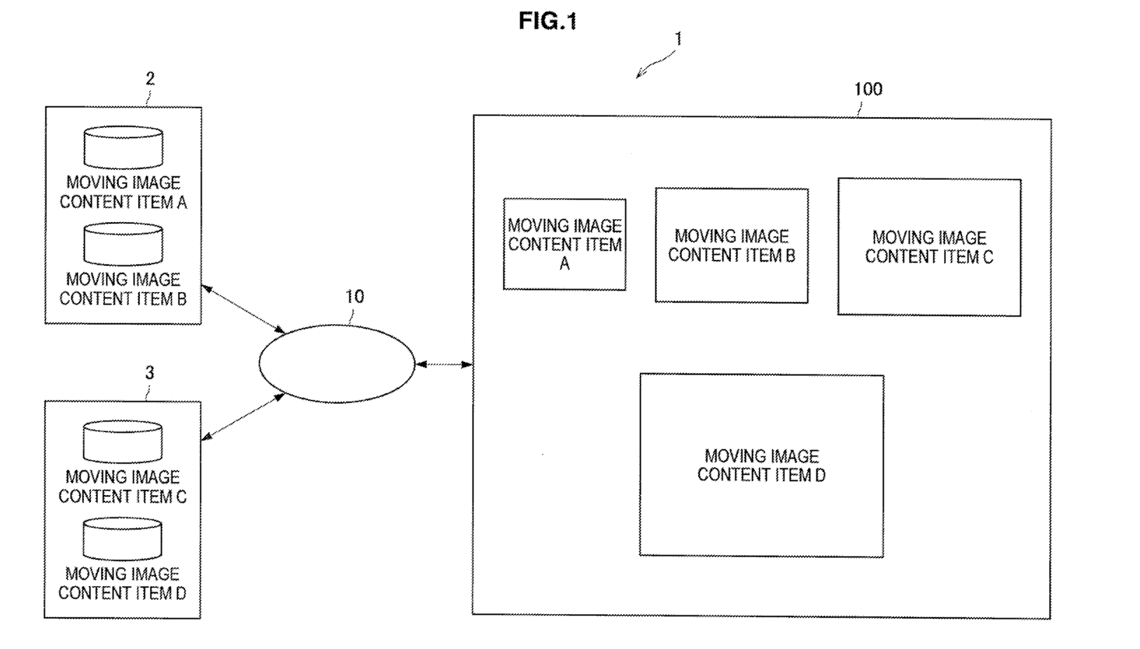

First of all, an overall configuration example of a system according to an embodiment of the present disclosure will be described with reference to drawings. FIG. 1 shows an overall configuration example of an image processing system 1 according to an embodiment of the present disclosure. The overall configuration example of the image processing system 1 according to an embodiment of the present disclosure will be described below with reference to FIG. 1.

The image processing system 1 shown in FIG. 1 has a configuration in which a client terminal 100 receives encoded stream information from a plurality of moving image content servers 2 and 3 through a network 10 such as the Internet, and the client terminal 100 acquires a plurality of moving image content items and reproduces the acquired moving image content items simultaneously.

The moving image content servers 2 and 3 each hold moving image content that is converted into encoded streams, convert moving image content into encoded streams, and transmit the encoded streams to the client terminal 100 in accordance with a request from the client terminal 100. In this embodiment, the moving image content server 2 holds a moving image content item A and a moving image content item B. The moving image content items A and B may each be a moving image content item that is shot in real time or a moving image content item that has been shot in advance. Further, the moving image content server 3 holds a moving image content item C and a moving image content item D. The moving image content items C and D may each be a moving image content item that is shot in real time or a moving image content item that has been shot in advance. It is needless to say that kinds and the number of moving image content items held by the moving image content servers are not limited to the above examples.

The encoded streams in this embodiment are encoded by an H.264/advanced video coding (AVC) scheme, for example.

The client terminal 100 receives a plurality of the encoded streams that are transmitted from the moving image content servers 2 and 3 through the network 10 such as the Internet, and decodes the received encoded streams. By decoding the plurality of encoded streams, the client terminal 100 can reproduce a plurality of moving image content items simultaneously. Note that the simultaneous reproduction of a plurality of moving image content items may be executed by the client terminal 100 or may be executed by another device having a display screen and connected to the client terminal 100 with or without wires.

In this embodiment, moving image content is distributed from the moving image content servers 2 and 3 to the client terminal 100 by adaptive streaming on an HTTP basis. As described above, in order to handle variation in bandwidth of the network 10 and diversity of display resolution of the client terminal, the adaptive streaming on an HTTP basis has a mechanism to select and provide the resolution and content rate of the moving image content.

Prior to reproduction of the moving image content, the client terminal 100 sends a query to the moving image content servers 2 and 3. For example, when the client terminal 100 sends a query about the moving image content item A provided by the moving image content server 2, the client terminal 100 can acquire the fact that the moving image content item A can be provided with any of the following bit rates: 1 Mbps or 2 Mbps when the resolution is 320×240 pixels; and 1 Mbps, 2 Mbps, or 3 Mbps when the resolution is 1024×768 pixels.

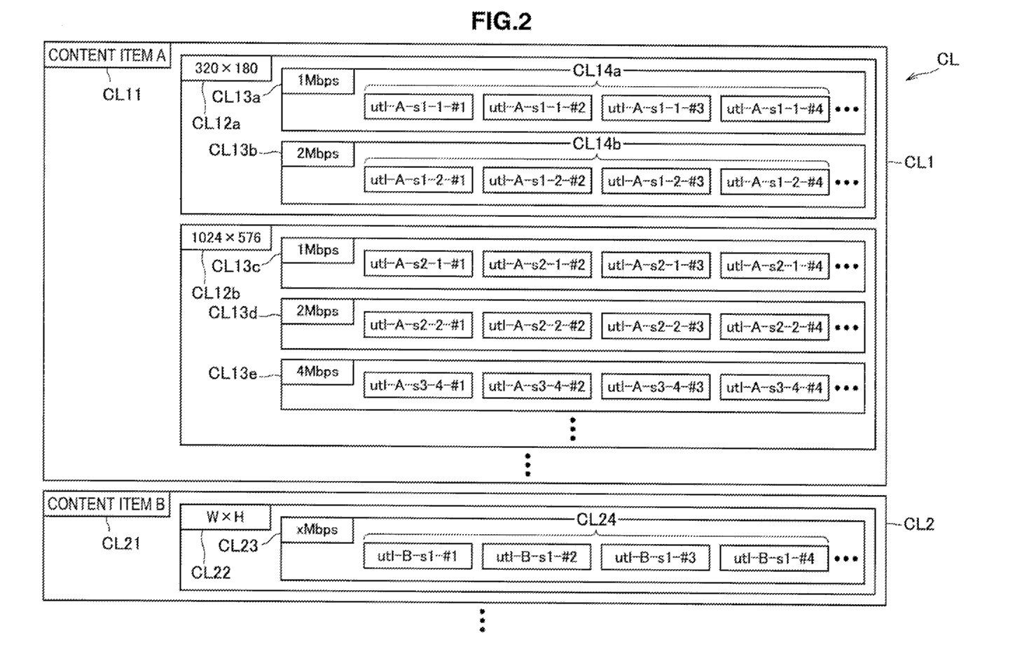

Examples of information that the client terminal 100 can obtain by sending a query to the moving image content servers 2 and 3 will be shown. FIG. 2 shows a conceptual diagram of a configuration of a content information list that the client terminal 100 can obtain by sending a query to the moving image content servers 2 and 3.

A content information list CL shown in FIG. 2 includes a content information list CL1 of the moving image content item A and a content information list CL2 of the moving image content item B.

The content information list CL1 for the moving image content item A includes a content name CL11, resolution information CL12a and CL12b, rate information CL13a to CL13e, and segment information CL14a and CL14b.

In a similar manner, the content information list CL2 of the moving image content item B includes a content name CL21, resolution information CL22, rate information CL23, and segment information CL24.

Although not shown in FIG. 2, the content information list CL also includes information showing a place where a file of the entity of content exists for each bit rate of each moving image content item. The information showing the place where the file of the entity of content exists can be a uniform resource locator (URL) of the file, for example.

By obtaining the content information list CL having the configuration shown in FIG. 2 from the moving image content servers 2 and 3, the client terminal 100 can acquire information on the resolution and bit rates prepared for the moving image content items A and B. Further, as shown in FIG. 2, each moving image content item is managed as a form of a segment information list for each resolution and bit rate. This segment information list is managed in a state where each moving image content item is divided into segments, that is, sectioned into certain period of times.

In a case of using an MPEG-DASH (ISO/IEC 23009-1), the moving image content servers 2 and 3 each hold a media presentation description (MPD) file that manages the subject of content to be distributed. In the MPD file, a moving image compression system, an image size, an encoding rate, a place to store a file of the moving image content are described. By acquiring the MPD file from the moving image content servers 2 and 3, the client terminal 100 can acquire information on the resolution or bit rate prepared for the moving image content items A and B.

In a case where the content information list CL having the configuration shown in FIG. 2 is acquired, when the moving image content item A having a high resolution is to be displayed on a screen, the client terminal 100 selects the moving image content item A with 1024×576 pixels, and when the moving image content item A having a low resolution is to be displayed on a screen, the client terminal 100 selects the moving image content item A with 320×180 pixels. Such selection makes it unnecessary for the client terminal 100 to convert the resolution of the moving image content item A. Further, it becomes possible to prevent useless consumption of band of the network 10 when the moving image content item A is transmitted from the moving image content server 2 to the client terminal 100.

Furthermore, the moving image content server 2 can provide content with the same resolution at a plurality of bit rates; accordingly, the client terminal 100 can estimate dynamically the bandwidth of the network 10 between the client terminal 100 and the moving image content server 2 and can select content at a bit rate that is lower than the estimated value.

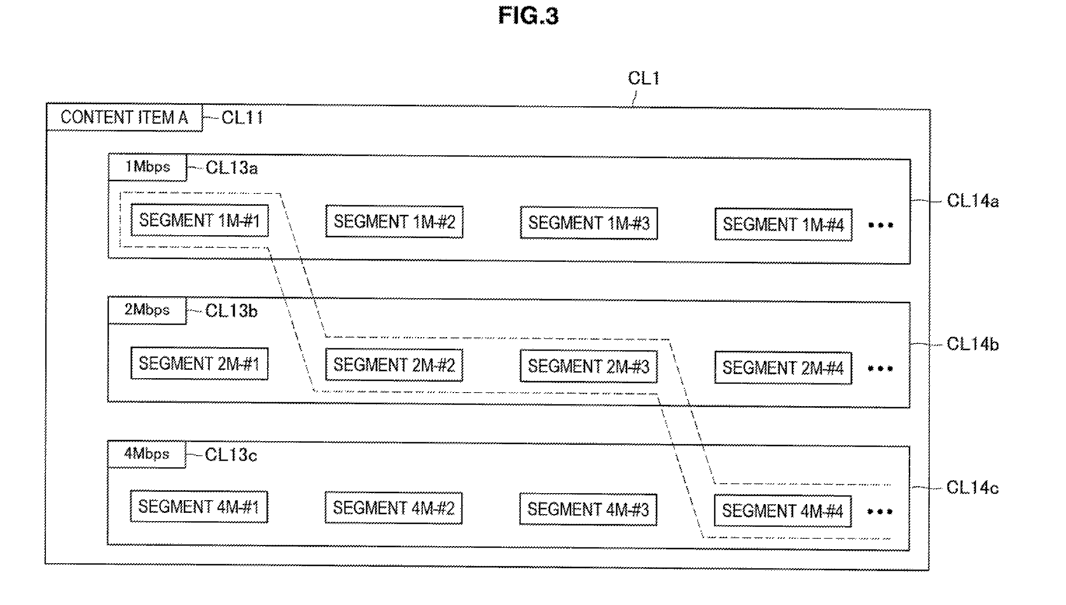

FIG. 3 shows an example where the client terminal 100 changes the rates and acquires segments. When the content information list CL1 shown in FIG. 3 is acquired from the moving image content server 2, the client terminal 100 can change the rates and acquire segments as shown in FIG. 3.

The example shown in FIG. 3 will be described in more detail. The client terminal 100 first decides to start streaming of the moving image content item A at 1 Mbps, which is the lowest bit rate, and acquires a segment 1M-#1. Then, from this state of acquiring the segment, when it is determined that the band of the network 10 has room, the client terminal 100 acquires a segment 2M-#2 and a segment 2M-#3 at 2 Mbps, which is the second lowest bit rate. When it is determined that the band of the network 10 still has room, the client terminal 100 acquires segments 4M-#4, . . . at 4 Mbps, which is the highest bit rate.

The moving image content is divided into segments so that content can be reproduced without discontinuity as long as the order thereof is kept even when the bit rates differ. Such a division of the moving image content in segment unit makes it possible to shorten the time until when the client terminal 100 starts streaming or to reproduce the content without discontinuity with a small buffer size even when the band of the network 10 varies.

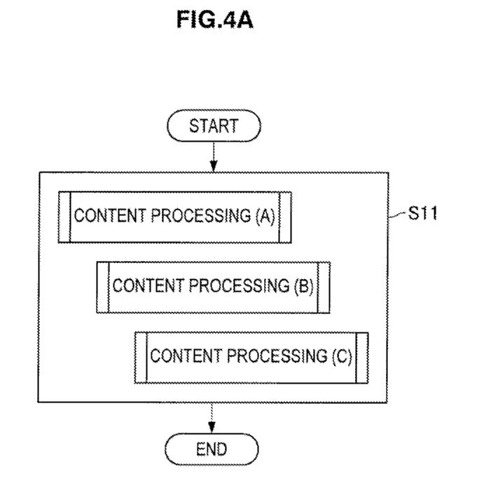

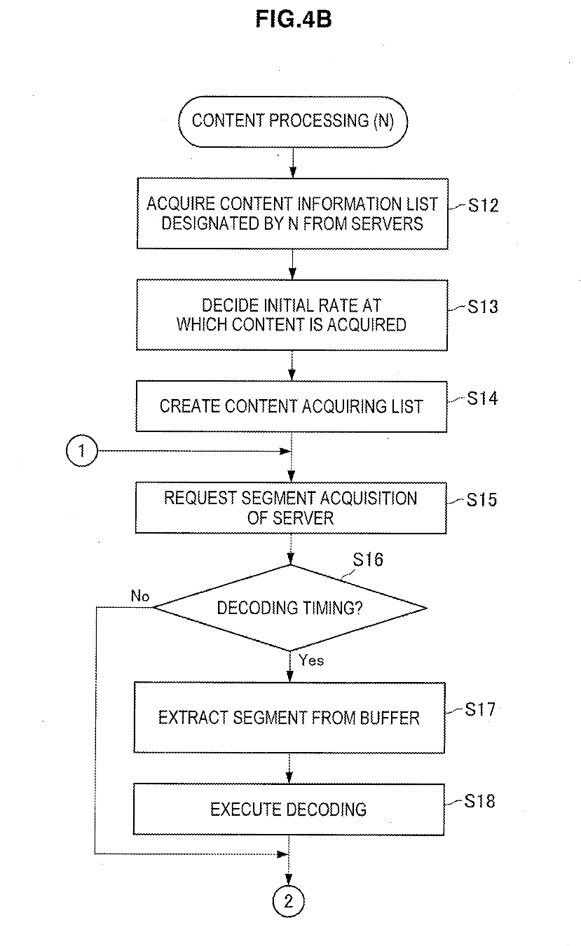

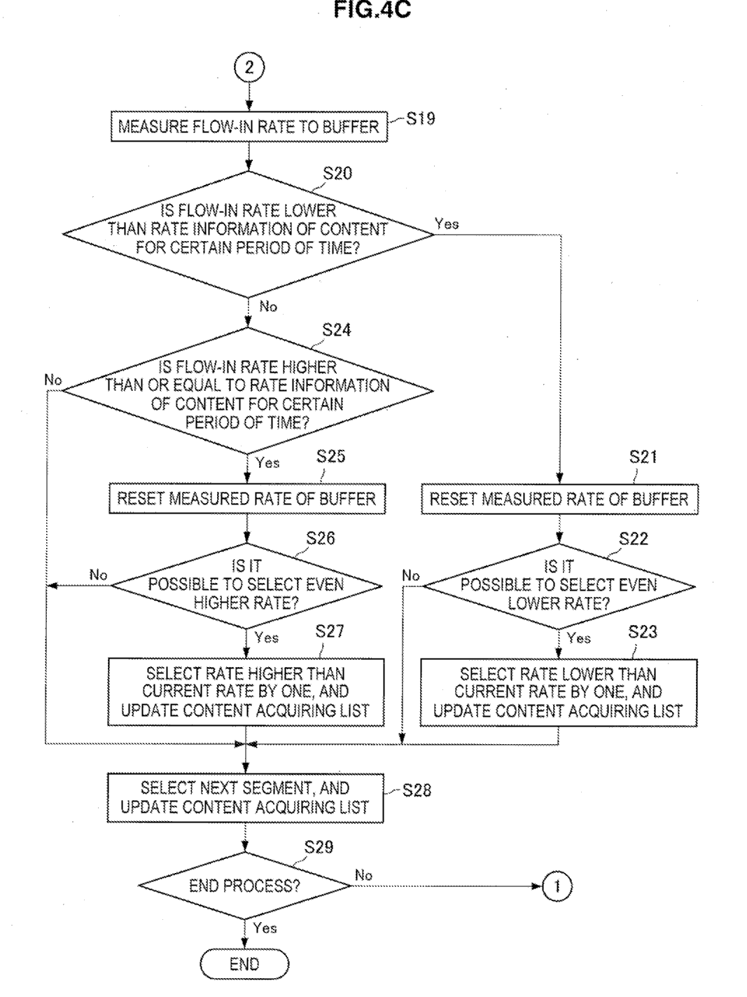

An overview of acquisition of the moving image content by the client terminal 100 using adaptive streaming will be described. FIGS. 4A to 4C each show a flow chart of an operation example of the client terminal 100, showing a process in which the client terminal 100 acquires a plurality of moving image content items using adaptive streaming.

As shown in FIG. 4A, the client terminal 100 executes a process of acquiring a plurality of moving image content items using adaptive streaming independently for each moving image content item (step S11). FIGS. 4B and 4C each show a flow chart focusing on one moving image content item in the process of acquiring moving image content items in step S11.

The client terminal 100 accesses the moving image content servers 2 and 3 and acquires a content information list in which various pieces of information of acquirable moving image content are described (step S12). After acquiring the content information list, the client terminal 100 decides an initial rate at which a relevant moving image content item N is acquired (step S13). In many cases, since a usable band of the network 10 is unknown at this step, the client terminal 100 desirably selects the lowest bit rate from among bit rates that can be selected.

After deciding the initial rate at which the moving image content item N is acquired in step S13, the client terminal 100 creates a content acquiring list for acquiring the moving image content item N (step S14). The content acquiring list is a list designating a resolution, a bit rate, and a segment in content item unit.

After creating the content acquiring list for acquiring the moving image content item N, the client terminal 100 requests, of the moving image content servers 2 and 3 that distribute the moving image content item N, a segment described in the content acquiring list (step S15). The moving image content servers 2 and 3 transmit the segment to the client terminal 100 in response to the request from the client terminal 100. The client terminal 100 holds the received segment in a buffer.

The client terminal 100 that has received the segment of the moving image content item N from the moving image content servers 2 and 3 determines whether or not it is decoding timing of the received segment (step S16). When it is the decoding timing, the client terminal 100 extracts the segment held in the buffer (step S17), and executes decoding (step S18).

Then, the client terminal 100 measures a flow-in rate to the buffer in which the segment is held (step S19). The client terminal 100 can calculate the flow-in rate to the buffer in a unit of bps as the bit rate using a time until completion of reception of one segment and a size of the segment, for example. Then, the client terminal 100 determines whether or not the flow-in rate to the buffer in which the segment is held is lower than bit rate information of the content acquiring list for a certain period of time (step S20). Since in an output side of the buffer, a decoder periodically extracts information in accordance with the bit rate information of the moving image content, the speed on a flow-in side of the buffer varies to be higher than or lower than the bit rate information of the moving image content in accordance with the state of the network 10.

As a result of the determination in step S20, when the flow-in rate to the buffer in which the segment is held is lower than the bit rate information of the content acquiring list for a certain period of time, the client terminal 100 resets the measured flow-in rate of the buffer (step S21), and determines whether or not it is possible to select a bit rate that is even lower than the bit rate of the content acquiring list (step S22). When the flow-in to the buffer is slow, the client terminal 100 determines that the network 10 does not have room, and decreases the rate of acquiring the moving image content from the moving image content servers 2 and 3.

As a result of the determination in step S22, when it is possible to select a bit rate that is even lower than the bit rate of the content acquiring list, the client terminal 100 selects a bit rate that is lower than the current bit rate and updates the content acquiring list (step S23).

As a result of the determination in step S20, when the flow-in rate to the buffer in which the segment is held is not lower than the bit rate information of the content acquiring list for a certain period of time, the client terminal 100 then determines whether or not the flow-in rate to the buffer in which the segment is held is higher than or equal to the bit rate information of the content acquiring list for a certain period of time (step S24).

As a result of the determination in step S24, when the flow-in rate to the buffer in which the segment is held is higher than or equal to the bit rate information of the content acquiring list for a certain period of time, the client terminal 100 resets the measured flow-in rate to the buffer (step S25), and determines whether or not it is possible to select a bit rate that is even higher than the bit rate of the content acquiring list (step S26). When the flow-in to the buffer is fast, the client terminal 100 determines that the network 10 has room and increases the rate of acquiring the moving image content from the moving image content servers 2 and 3.

As a result of the determination in step S26, when it is possible to select a bit rate that is even higher than the bit rate of the content acquiring list, the client terminal 100 selects a bit rate that is higher than the current bit rate and updates the content acquiring list (step S27).

The client terminal 100 updates the content acquiring list in order to select the next segment (step S28). Then, the client terminal 100 continues a series of processes until when the process of acquiring the moving image content is completed (step S29).

In the above manner, in the adaptive streaming, it is possible to handle variation in bandwidth of the network 10 and diversity of display resolution of the client terminal 100. However, when a plurality of moving image content items are to be displayed on one screen of the client terminal 100, since bit rates of the acquired moving image content are decided independently, all the moving image content items are reproduced at as high bit rates as possible.

Accordingly, when a plurality of moving image content items are to be displayed on one screen of the client terminal 100, a bit rate that is higher than necessary can be allocated to a content item that is supposed to be sufficiently displayed at a low bit rate, or a sufficiently high bit rate cannot be allocated to a content item that requires a high bit rate.

For example, a case will be considered where two moving image content items having a resolution of 320×240 pixels and a resolution of 1280×1024 pixels, respectively, are simultaneously reproduced in the client terminal 100 connected to the moving image content servers 2 and 3 with a band of 10 Mbps through the network 10. Note that the bit rate of the moving image content that can be provided by the moving image content servers 2 and 3 is assumed to be at least 1 Mbps and be able to be incremented, by one, to 10 Mbps at most.

In a case where the client terminal 100 starts reproducing the moving image content items under this condition, as time passes, the bit rates of all the moving image content items become stable at 5 Mbps. This is because a transmission control protocol (TCP) used as a transport protocol below HTTP has a nature of uniformly dividing bands with respect to a plurality of connections sharing the same link. This is also because the client terminal 100 decides the bit rates of the moving image content items acquired from the moving image content servers 2 and 3 independently for each moving image content item.

In general, when a relatively high bit rate is allocated to moving image content having a high resolution and a relatively low bit rate is allocated to moving image content having a low resolution, satisfactory results can be obtained in terms of quality of content.

Accordingly, it becomes possible to provide effective information for users without wasteful consumption of the band when different bit rates can be allocated in the following manner, for example: 2 Mbps is allocated to a moving image content item having a low resolution of 320×240 pixels and 8 Mbps is allocated to a moving image content item having a high resolution of 1280×1024 pixels.

As a measure against this circumstance, by designating a maximum usable band for each connection from application to a TCP layer, for example, bit rates of each moving image content item can meet the above-described demand. However, the TCP is packaged in a kernel of an OS in many systems, so that this measure is difficult when considering the package.

Accordingly, the client terminal 100 that can reproduce a plurality of moving image content items effectively and prevent wasteful consumption of the band of the network, when displaying the plurality of moving image content items on a screen, will be described below.

### Function Configuration Example of Client Terminal

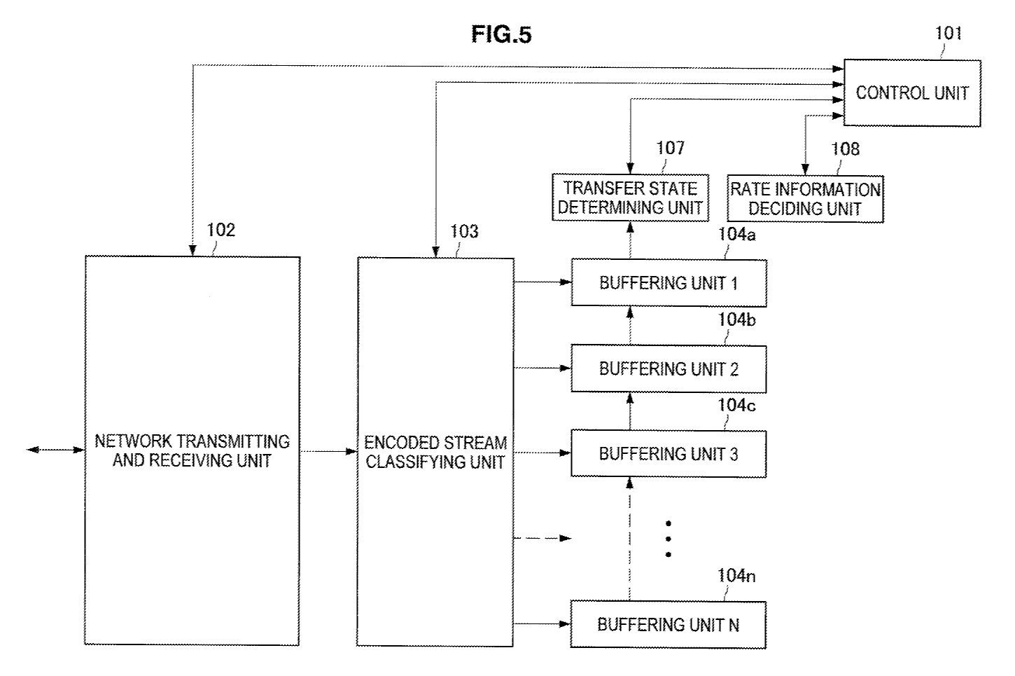

FIG. 5 shows a function configuration example of the client terminal 100 according to an embodiment of the present disclosure. FIG. 5 shows an example of the client terminal 100 having a configuration that decodes encoded streams transmitted from the moving image content servers 2 and 3 and reproduces a plurality of moving image content items simultaneously. The function configuration example of the client terminal 100 according to an embodiment of the present disclosure will be described below with reference to FIG. 5.

As shown in FIG. 5, the client terminal 100 according to an embodiment of the present disclosure includes a control unit 101, a network transmitting and receiving unit 102, an encoded stream classifying unit 103, content buffering units 104a, 104b, 104c, . . . , 104n, a transfer state determining unit 107, and a rate information deciding unit 108.

The control unit 101 controls operation of each element in the client terminal 100. The network transmitting and receiving unit 102 receives data from the network 10 and transmits data to the network 10 under control of the control unit 101. In this embodiment, the network transmitting and receiving unit 102 receives the encoded streams transmitted from the moving image content servers 2 and 3. The network transmitting and receiving unit 102 outputs the received encoded streams to the encoded stream classifying unit 103 in accordance with control of the control unit 101. Since the network transmitting and receiving unit 102 can receive a plurality of encoded streams simultaneously, when a plurality of encoded streams are received, the plurality of encoded streams are classified by the encoded stream classifying unit 103 in a latter stage.

The encoded stream classifying unit 103 classifies the encoded streams that the network transmitting and receiving unit 102 has received, in moving image content unit. As described above, since the network transmitting and receiving unit 102 can receive a plurality of encoded streams simultaneously, when a plurality of encoded streams are received, the encoded stream classifying unit 103 classifies the plurality of encoded streams in moving image content unit. The encoded stream classifying unit 103 can classify the encoded streams in moving image content unit by referring to information for identifying content contained in the received encoded streams, for example. After classifying the encoded streams in moving image content unit, the encoded stream classifying unit 103 outputs the classified encoded streams to the content buffering units 104a, 104b, 104c, . . . , 104n in moving image content unit.

The content buffering units 104a, 104b, 104c, . . . , 104n each hold, in moving image content unit, the encoded streams classified by the encoded stream classifying unit 103 in moving image content unit. The encoded streams held in the respective content buffering units 104a, 104b, 104c, . . . , 104n in moving image content unit are extracted by a decoder (not shown) to be decoded.

The transfer state determining unit 107 determines the transfer state of the moving image content items from the moving image content servers 2 and 3 to the client terminal 100. Specifically, the transfer state determining unit 107 determines the transfer state by measuring a packet loss rate or a flow-in rate to the content buffering units 104a, 104b, 104c, . . . , 104n. After determining the transfer state of the moving image content items from the moving image content servers 2 and 3 to the client terminal 100, the transfer state determining unit 107 transmits the determination results to the control unit 101.

The rate information deciding unit 108 decides distribution rates of moving image content items distributed from the moving image content servers 2 and 3. The rate information deciding unit 108 functions as an example of a bandwidth deciding unit according to an embodiment of the present disclosure. The rate information deciding unit 108 decides the distribution rates of moving image content items distributed from the moving image content servers 2 and 3 based on setting set by a user of the client terminal 100 or the transfer state determined by the transfer state determining unit 107, for example. The rate information deciding unit 108 transmits information on the decided distribution rates of moving image content items to the control unit 101.

The client terminal 100 according to an embodiment of the present disclosure does not execute processes of a plurality of moving image content items independently when handling a plurality of moving image content items. The client terminal 100 according to an embodiment of the present disclosure decides, when deciding bit rates of the moving image content items to be received, a ratio between bands that can be used by the respective moving image content items considering the total acquiring rates of the selected moving image content items and the state of all buffers.

The client terminal 100 according to an embodiment of the present disclosure decides the ratio between bands that can be used by the respective moving image content items in this manner, thereby reproducing the moving image content items effectively and preventing wasteful consumption of the band of the network.

The function configuration example of the client terminal 100 according to an embodiment of the present disclosure has been described above with reference to FIG. 5. Next, an operation example of the client terminal 100 according to an embodiment of the present disclosure will be described.

### Operation Example of Client Terminal

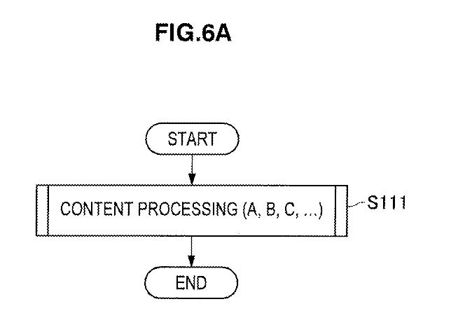

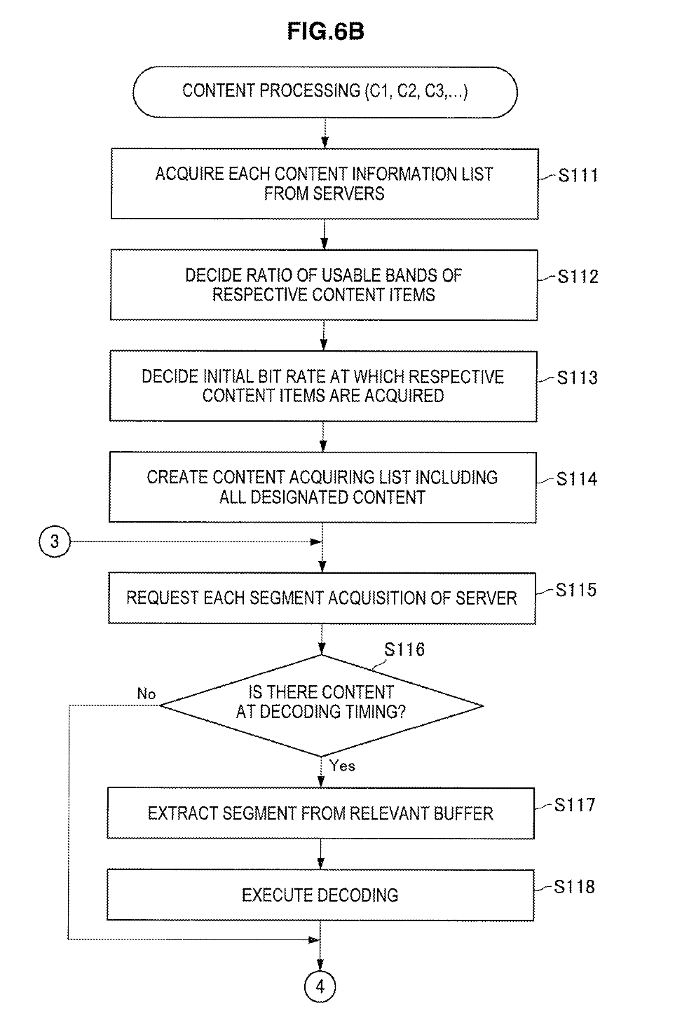

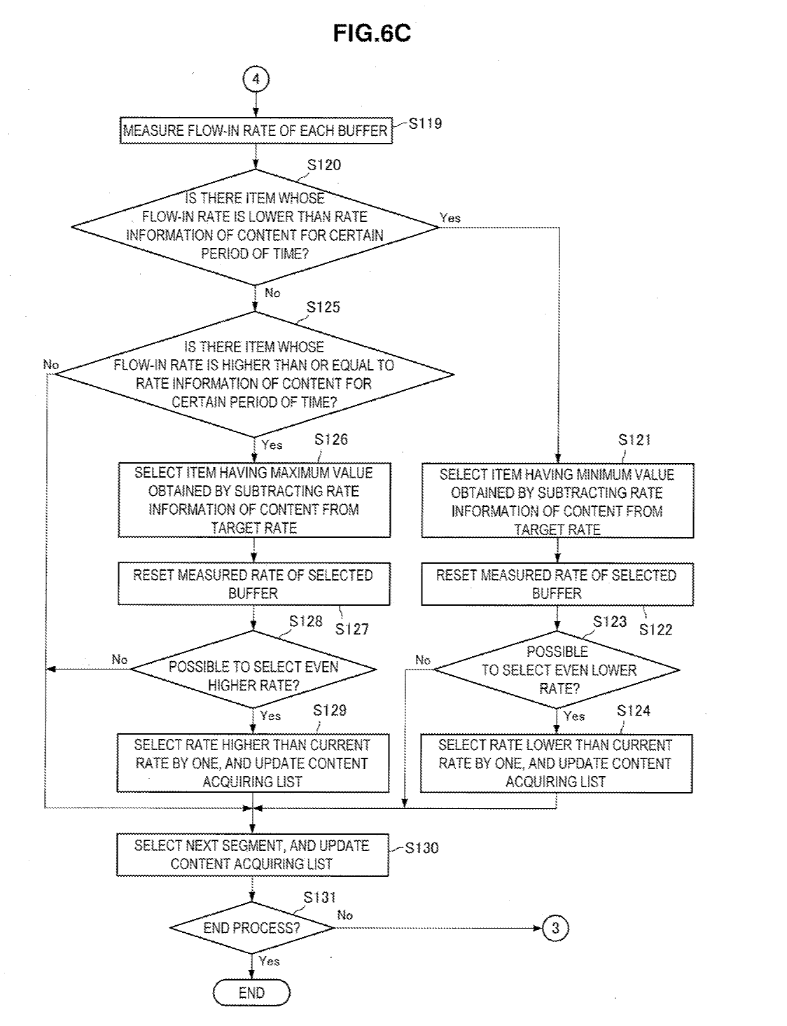

FIGS. 6A to 6C are each a flow chart showing an operation example of the client terminal 100 according to an embodiment of the present disclosure. The flow charts shown in FIGS. 6A to 6C each show a process in which the client terminal 100 acquires a plurality of moving image content items using adaptive streaming. In this process of acquiring a plurality of moving image content items, unlike in the above-described process, the ratio between bands that can be used by the respective moving image content items is decided by considering the total acquiring rates of the selected moving image content items and the state of all buffers. The operation example of the client terminal 100 according to an embodiment of the present disclosure will be described below with reference to FIGS. 6A to 6C.

The processes shown in FIGS. 4A to 4C are executed independently for each moving image content item. In contrast, the processes shown in FIG. 6A to 6C are executed for all the moving image content items. The client terminal 100 executes the process of acquiring the plurality of moving image content items using adaptive streaming for all the moving image content items as shown in FIG. 6A (step S101). FIGS. 6B and 6C are each a flow chart showing the process of acquiring the moving image content items in step S101.

The client terminal 100 accesses the moving image content servers 2 and 3 and acquires a content information list in which various pieces of information of acquirable moving image content are described, for all the moving image content items to be received (step S111). The control unit 101 can execute this acquiring process, for example.

After acquiring the content information list in step S111, the client terminal 100 decides a ratio between usable bands of the respective moving image content items to be acquired (step S112). The rate information deciding unit 108 can execute the process in step S112, for example.

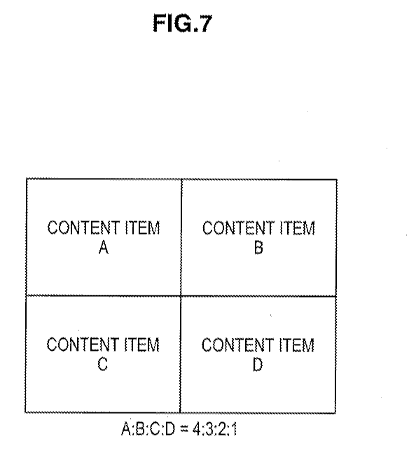

A specific example will be described. FIG. 7 shows an example of decision of the ratio between usable bands of the respective moving image content items. FIG. 7 shows an example in which the ratio between usable bands of moving image content items A to D having the same resolution is decided. On the assumption that an instruction is made such that the bands are allocated to the respective moving image content items at a ratio of 4:3:2:1, when the band of the network 10 that can be used by the client terminal 100 is 10 Mbps, the client terminal 100 decides the ratio between usable bands such that 4 Mbps, 3 Mbps, 2 Mbps, and 1 Mbps are allocated to the moving image content item A, the moving image content item B, the moving image content item C, and the moving image content item D, respectively. Further, when the band of the network 10 that can be used by the client terminal 100 is 20 Mbps, the client terminal 100 decides the ratio between usable bands such that 8 Mbps, 6 Mbps, 4 Mbps, and 2 Mbps are allocated to the moving image content item A, the moving image content item B, the moving image content item C, and the moving image content item D, respectively.

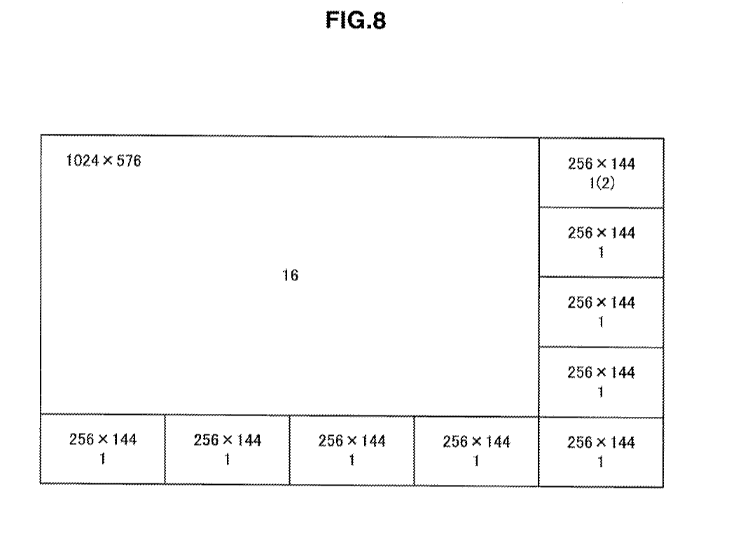

FIG. 8 shows an example of decision of the ratio between usable bands of the respective moving image content items. In the example shown in FIG. 8, the ratio between usable bands of the moving image content items having different resolutions is decided. In the example shown in FIG. 8, the client terminal 100 allocates 16 to a moving image content item having a resolution of 1024×576 when the usable band of a moving image content item having a resolution of 256×144 is 1. In the example shown in FIG. 8, the client terminal 100 simply and directly uses an area ratio between the moving image content items as the ratio between usable bands. Note that when a user wants to focus on one moving image content item having a resolution of 256×144, for example, the client terminal 100 can allocate 2 or more to this moving image content item.

After deciding the ratio between usable bands of the respective moving image content items acquired in step S112, the client terminal 100 decides an initial bit rate at which the respective moving image content items are acquired (step S113). The rate information deciding unit 108 can execute the process in step S113, for example.

As described above, in many cases, since the usable band of the network 10 is unknown at this step, the client terminal 100 desirably selects the lowest bit rate from among bit rates that can be selected. It is needless to say that the client terminal 100 may decide the initial bit rate at which the respective moving image content items are acquired based on the ratio decided in step S112 as long as information about the usable band of the network 10 is able to be acquired in advance.

After deciding the initial bit rate at which the respective moving image content items are acquired in step S113, the client terminal 100 creates a content acquiring list for acquiring the respective moving image content items (step S114). The control unit 101 can execute the process in step S114, for example. The content acquiring list is a list designating a resolution, a bit rate, and a segment in content item unit.

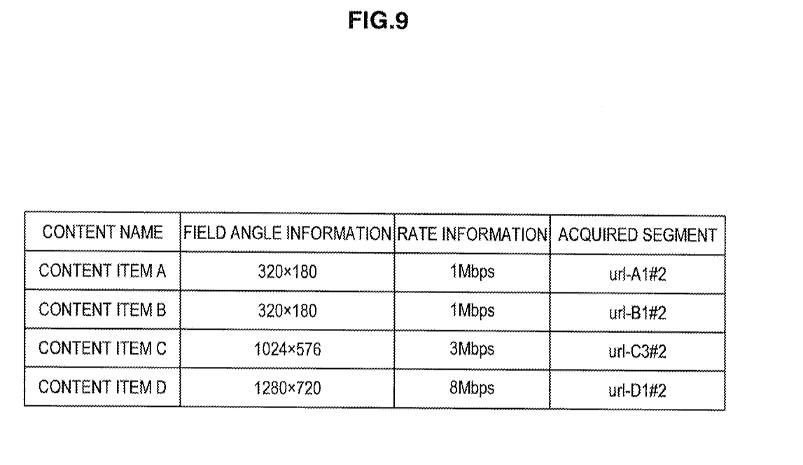

FIG. 9 shows an example of the content acquiring list created in step S114. In the content acquiring list shown in FIG. 9, information such as the resolution, the bit rate, and the acquired segment are described for each of the moving image content items A to D.

After creating the content acquiring list in step S114, the client terminal 100 requests, of the moving image content servers 2 and 3 that distribute moving image content, segments described in the created content acquiring list (step S115). The control unit 101 can execute the process in step S115, for example. The moving image content servers 2 and 3 transmit the segments to the client terminal 100 in response to the request from the client terminal 100. The client terminal 100 holds the received segments in the content buffering units 104a, 104b, 104c, . . . , 104n.

The client terminal 100 that has received the segments of the moving image content items from the moving image content servers 2 and 3 determines whether or not there is a moving image content item at decoding timing (step S116). The control unit 101 can execute the process in step S116, for example. When there is a moving image content item at decoding timing, the client terminal 100 extracts the segments held in the content buffering units 104a, 104b, 104c, . . . , 104n (step S117) and executes decoding (step S118).

Then, the client terminal 100 measures a flow-in rate to the buffer in which the segment is held (step S119). The transfer state determining unit 107 can execute the process in step S119, for example. The transfer state determining unit 107 can calculate the flow-in rate to the buffer in a unit of bps as the bit rate using a time until completion of reception of one segment and a size of the segment, for example.

After measuring the flow-in rate to each buffer in which the segment is held in step S119, the client terminal 100 determines whether or not there is a moving image content item whose flow-in rate to the buffer in which the segment is held is lower than bit rate information of the content acquiring list for a certain period of time (step S120). The control unit 101 can execute the process in step S120. As described above, since in an output side of the content buffering units 104a, 104b, 104c, . . . , 104n, a decoder periodically extracts information in accordance with the bit rate information of the moving image content, the speed on a flow-in side of the content buffering units 104a, 104b, 104c, . . . , 104n varies to be higher than or lower than the bit rate information of the moving image content in accordance with the state of the network 10.

As a result of the determination in step S120, when there is a moving image content item whose flow-in rate to the buffer in which the segment is held is lower than the bit rate information of the content acquiring list for a certain period of time, the client terminal 100 selects a moving image content item having a minimum value obtained by subtracting the bit rate information of the content acquiring list from a target rate (step S121). The rate information deciding unit 108 can execute the process in step S121, for example.

The target rate here refers to an index that is calculated for each moving image content item acquired by the client terminal 100, and is obtained by (sum of bit rate information of content items being acquired)×(an allocation ratio between moving image content items).

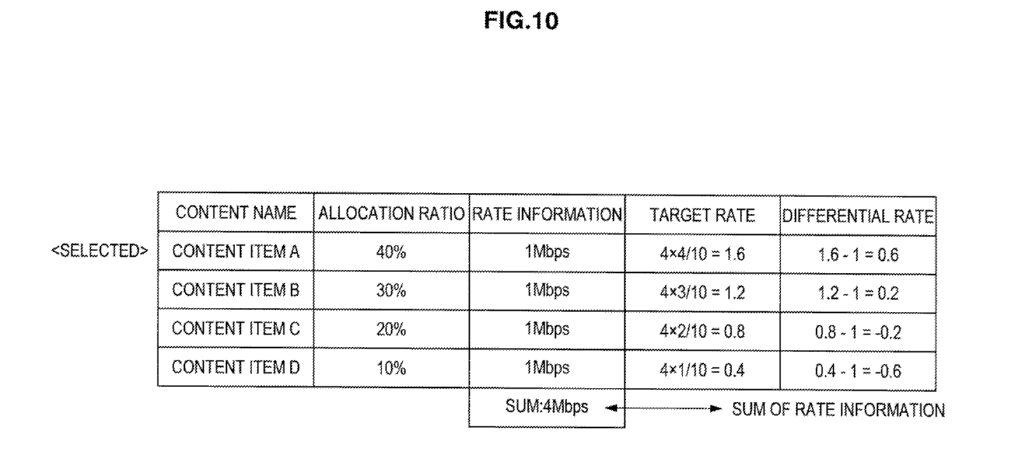

FIG. 10 shows an example of calculation of target rates. FIG. 10 shows the example of calculation of the target rates when the allocation ratio is decided as shown in FIG. 7. Note that it is assumed that 1.0 Mbps is selected as the initial bit rate information of the respective moving image content items. In this case, the sum of the bit rate information of the respective moving image content items is 4.0 Mbps; accordingly, the target rates of the respective moving image content items are calculated as shown in FIG. 10.

After selecting, in step S121, the moving image content item having the minimum value obtained by subtracting the bit rate information of the content acquiring list from the target rate, the client terminal 100 resets the measured flow-in rate to the buffer (step S122) and determines whether or not it is possible to select a bit rate that is even lower than the bit rate of the content acquiring list, for the moving image content item selected in step S121 (step S123).

As a result of the determination in step S123, when it is possible to select a bit rate that is even lower than the bit rate of the content acquiring list for the moving image content item selected in step S121, the client terminal 100 selects a bit rate that is lower than the current bit rate for the moving image content item selected in step S121 and updates the content acquiring list (step S124).

Meanwhile, as a result of the determination in step S120, when there is no moving image content item whose flow-in rate to the buffer in which the segment is held is lower than bit rate information of the content acquiring list for a certain period of time, the client terminal 100 then determines whether or not there is a moving image content item whose flow-in rate to the buffer in which the segment is held is higher than or equal to bit rate information of the content acquiring list for a certain period of time (step S125). The control unit 101 can execute the process in step S120.

As a result of the determination in step S125, when there is a moving image content item whose flow-in rate to the buffer in which the segment is held is higher than or equal to the bit rate information of the content acquiring list for a certain period of time, the client terminal 100 selects a moving image content item having a maximum value obtained by subtracting the bit rate information of the content acquiring list from a target rate (step S126). The rate information deciding unit 108 can execute the process in step S126, for example.

After selecting, in step S126, the moving image content item having the maximum value obtained by subtracting the bit rate information of the content acquiring list from the target rate, the client terminal 100 resets the measured flow-in rate to the buffer (step S127) and determines whether or not it is possible to select a bit rate that is even higher than the bit rate of the content acquiring list for the moving image content item selected in step S126 (step S128).

As a result of the determination in step S128, when it is possible to select a bit rate that is even higher than the bit rate of the content acquiring list for the moving image content item selected in step S126, the client terminal 100 selects a bit rate that is higher than the current bit rate for the moving image content item selected in step S126 and updates the content acquiring list (step S129).

The client terminal 100 updates the content acquiring list in order to select the next segment (step S130). Then, the client terminal 100 continues a series of processes until when the process of acquiring the moving image content is completed (step S131).

When the target rates and differential rates are calculated as shown in FIG. 10 and the acquiring rate of each moving image content item is 1 Mbps, it is found that the rate of the moving image content item A is lower than the target rate by 0.6 Mbps, the rate of the moving image content item B is lower than the target rate by 0.2 Mbps, the rate of the moving image content item C is higher than the target rate by 0.2 Mbps, and the rate of the moving image content item D is higher than the target rate by 0.6 Mbps.

In a case where the acquiring rates and the target rates of the respective moving image content items are set as shown in FIG. 10, the moving image content item A is selected in step S126. This is because the moving image content item A has the maximum value obtained by subtracting the bit rate information of the content acquiring list from the target rate.

The moving image content item A also includes rate information of 2 Mbps. Therefore, the client terminal 100 selects 2 Mbps as a bit rate that is higher than the current bit rate for the moving image content A in the process in step S129. Then, the client terminal 100 prepares to acquire the moving image content item A at a new bit rate in the process in step S130.

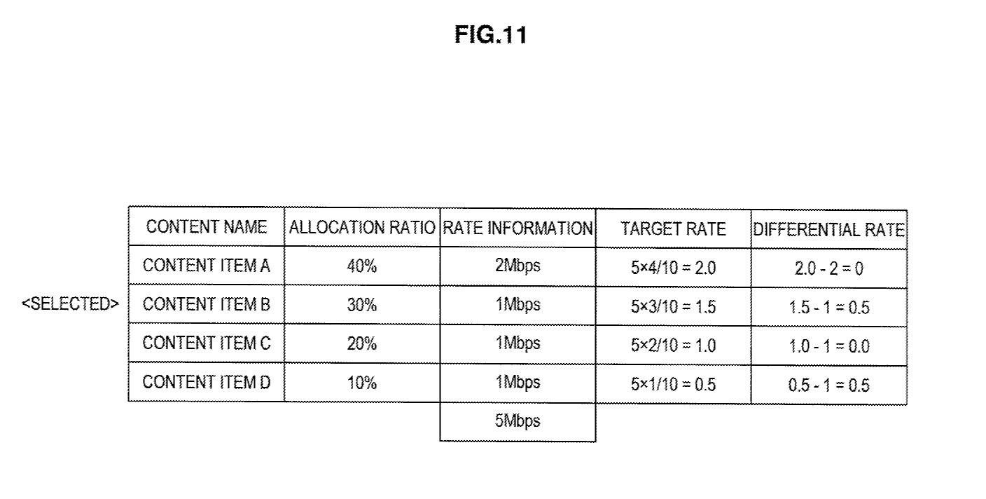

FIG. 11 shows values of target rates and differential rates when the bit rate of the moving image content item A is increased from the state shown in FIG. 10. Since the bit rate of the moving image content item A is increased, the sum of the bit rate information is changed to 5 Mbps. Further, the target rate and the differential rate of each moving image content item are obtained as shown in FIG. 11.

When the target rates and the differential rates are calculated as shown in FIG. 11, the moving image content item B having the maximum value obtained by subtracting the bit rate information of the content acquiring list from the target rate is selected.

The moving image content item B also includes rate information of 2 Mbps. Therefore, the client terminal 100 selects 2 Mbps as a bit rate that is higher than the current bit rate for the moving image content item B in the process in step S129. Then, the client terminal 100 prepares to acquire the moving image content item B at a new bit rate in the process in step S130.

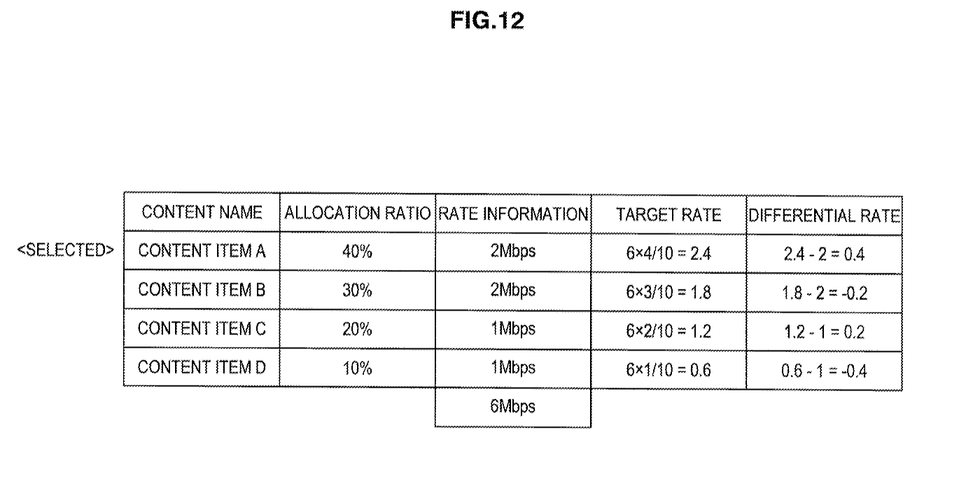

FIG. 12 shows values of target rates and differential rates when the bit rate of the moving image content item B is increased from the state shown in FIG. 11. Since the bit rate of the moving image content item B is increased, the sum of the bit rate information is changed to 6 Mbps. Further, the target rate and the differential rate of each moving image content item are obtained as shown in FIG. 12.

When the target rates and the differential rates are calculated as shown in FIG. 12, the moving image content item A having the maximum value obtained by subtracting the bit rate information of the content acquiring list from the target rate is selected again.

The moving image content item A also includes rate information of 3 Mbps. Therefore, the client terminal 100 selects 3 Mbps as a bit rate that is higher than the current bit rate for the moving image content item A in the process in step S129. Then, the client terminal 100 prepares to acquire the moving image content item A at a new bit rate in the process in step S130.

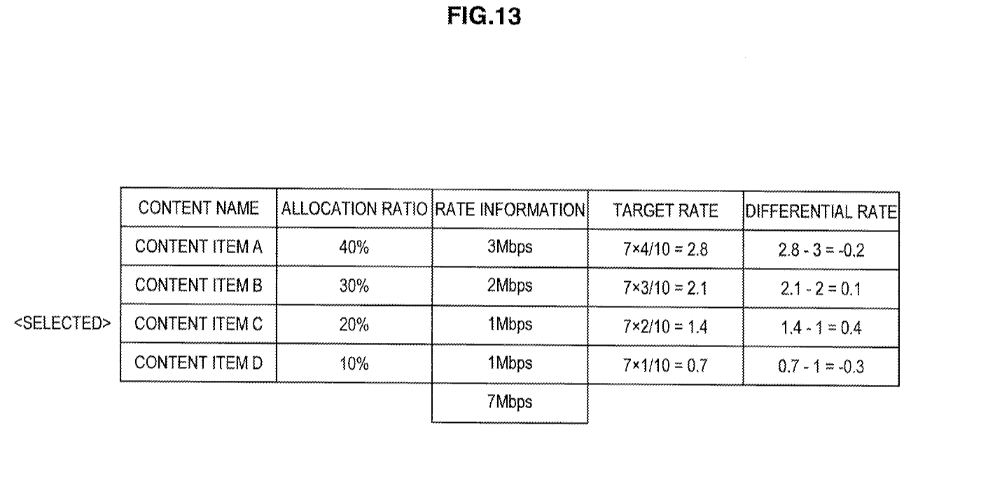

FIG. 13 shows values of target rates and differential rates when the bit rate of the moving image content item A is increased from the state shown in FIG. 12. Since the bit rate of the moving image content item A is increased, the sum of the bit rate information is changed to 7 Mbps. Further, the target rate and the differential rate of each moving image content item are obtained as shown in FIG. 13.

When the target rates and the differential rates are calculated as shown in FIG. 13, the moving image content item C having the maximum value obtained by subtracting the bit rate information of the content acquiring list from the target rate is selected.

The moving image content item C also includes rate information of 2 Mbps. Therefore, the client terminal 100 selects 2 Mbps as a bit rate that is higher than the current bit rate for the moving image content item C in the process in step S129. Then, the client terminal 100 prepares to acquire the moving image content item C at a new bit rate in the process in step S130.

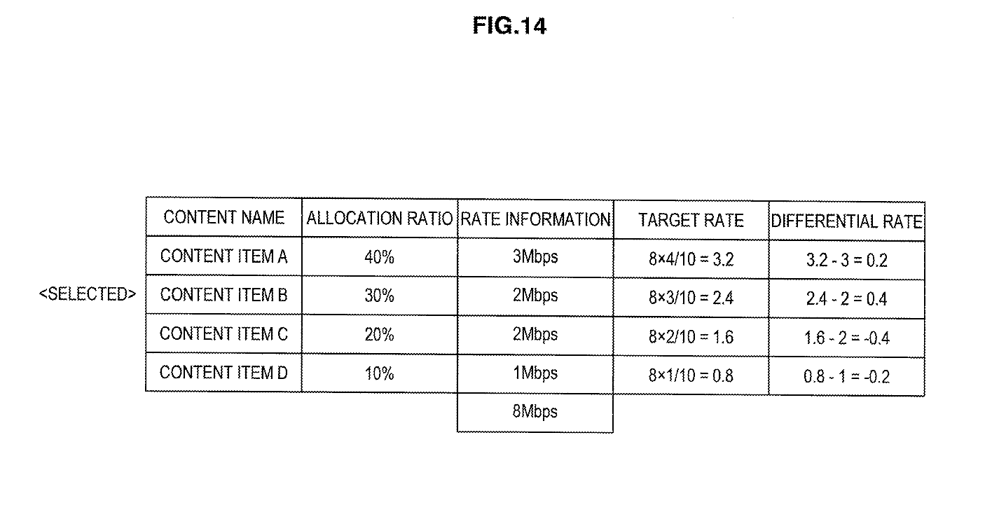

FIG. 14 shows values of target rates and differential rates when the bit rate of the moving image content item C is increased from the state shown in FIG. 13. Since the bit rate of the moving image content item C is increased, the sum of the bit rate information is changed to 8 Mbps. Further, the target rate and the differential rate of each moving image content item are obtained as shown in FIG. 14.

When the target rates and the differential rates are calculated as shown in FIG. 14, the moving image content item B having the maximum value obtained by subtracting the bit rate information of the content acquiring list from the target rate is selected again.

The moving image content item B also includes rate information of 3 Mbps. Therefore, the client terminal 100 selects 3 Mbps as a bit rate that is higher than the current bit rate for the moving image content item B in the process in step S129. Then, the client terminal 100 prepares to acquire the moving image content item B at a new bit rate in the process in step S130.

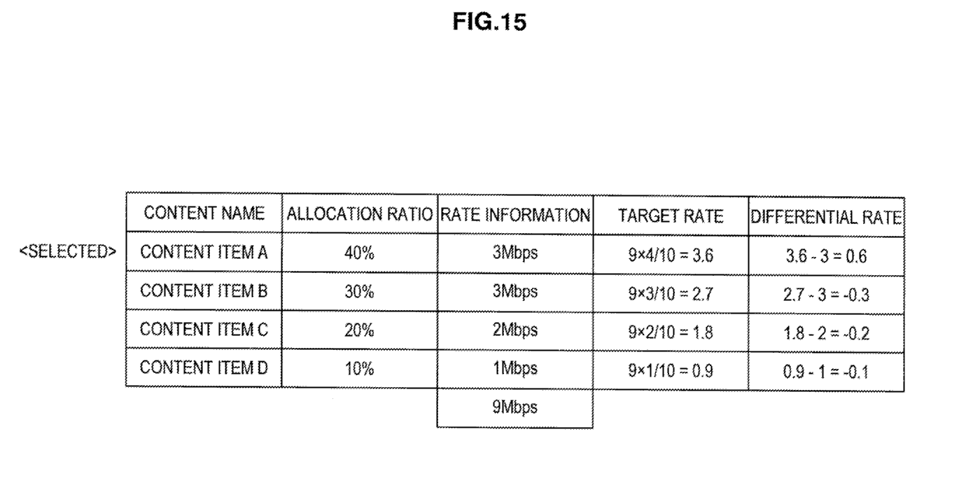

FIG. 15 shows values of target rates and differential rates when the bit rate of the moving image content item B is increased from the state shown in FIG. 14. Since the bit rate of the moving image content item B is increased, the sum of the bit rate information is changed to 9 Mbps. Further, the target rate and the differential rate of each moving image content item are obtained as shown in FIG. 15.

When the target rates and the differential rates are calculated as shown in FIG. 15, the moving image content item A having the maximum value obtained by subtracting the bit rate information of the content acquiring list from the target rate is selected for the third time.

The moving image content item A also includes rate information of 4 Mbps. Therefore, the client terminal 100 selects 4 Mbps as a bit rate that is higher than the current bit rate for the moving image content item A in the process in step S129. Then, the client terminal 100 prepares to acquire the moving image content item A at a new bit rate in the process in step S130.

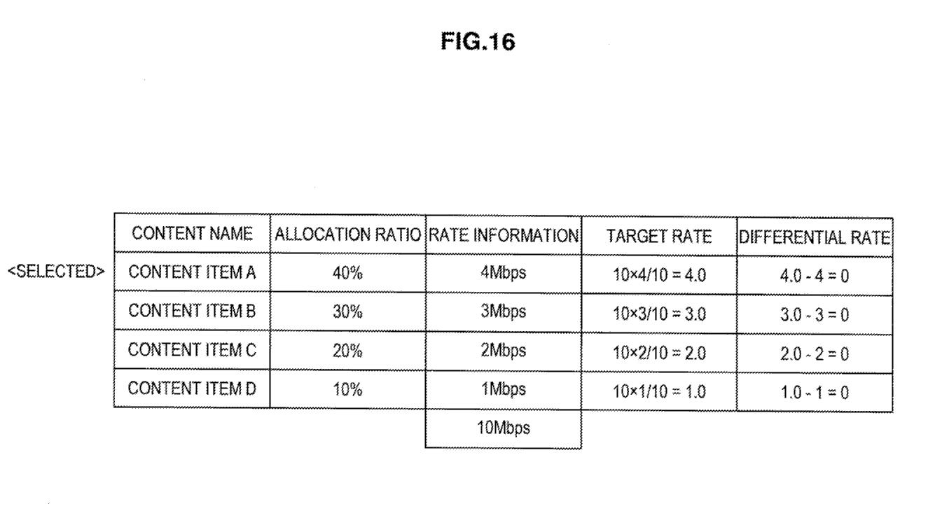

FIG. 16 shows values of target rates and differential rates when the bit rate of the moving image content item A is increased from the state shown in FIG. 15. Since the bit rate of the moving image content item A is increased, the sum of the bit rate information is changed to 10 Mbps. Further, the target rate and the differential rate of each moving image content item are obtained as shown in FIG. 16.

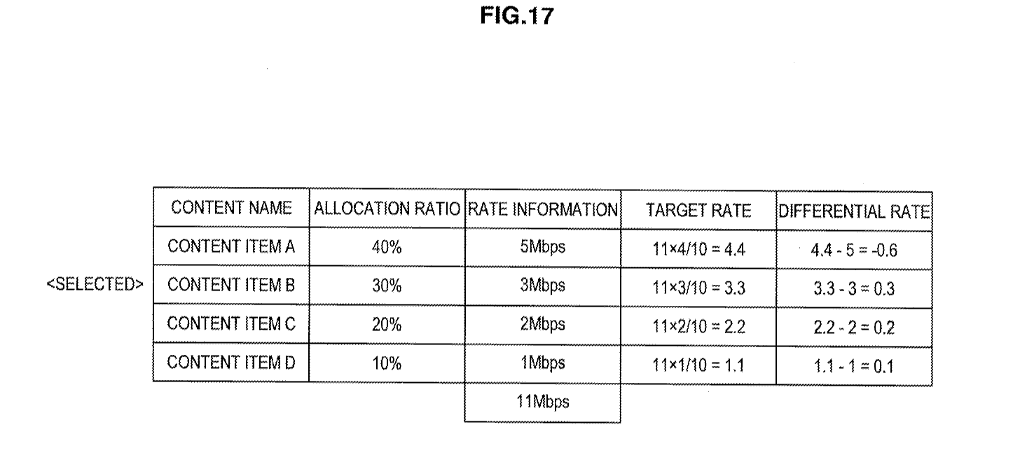

FIG. 16 shows a state where the differential rates of all the moving image content items are 0. Therefore, when the bit rate of each moving image content item is designated as shown in FIG. 16, the bit rates of the respective moving image content items have the ratio designated in step S112. In such a state where the bit rate of each moving image content item is designated as shown in FIG. 16, when it is possible to further increase the bit rate of the moving image content as a result of measurement of the rate in step S119 and the determination in step S125, the client terminal 100 can further increase the bit rate of the moving image content item A having the highest value in the allocation ratio, for example. FIG. 17 shows values of target rates and differential rates when the bit rate of the moving image content item A is further increased from the state shown in FIG. 16.

By calculating target rates and differential rates and increasing the bit rate of the moving image content item having the greatest difference in this manner, the client terminal 100 according to an embodiment of the present disclosure can reproduce moving image content effectively and prevent wasteful consumption of the band of the network.

Although the above example shows a case where target rates and differential rates are calculated and the bit rate of the moving image content item having the greatest difference is increased, the client terminal 100 according to an embodiment of the present disclosure can execute a similar process in an opposite manner. That is, the client terminal 100 according to an embodiment of the present disclosure can calculate target rates and differential rates and decrease a bit rate of the moving image content item having the smallest difference (when the differential rate is a negative value, a difference having the greatest absolute value).

Further, although the above example shows a simple case where the prepared bit rates of all the moving image content items increment by one Mbps, it is needless to say that the idea of this embodiment can be applied to a case where the bit rates of the moving image content items are prepared in various modes.

For example, a case will be considered where the bit rate of the moving image content item A changes by 2 Mbps and the bit rate of the moving image content item B is changed by 100 kbps. In this case, when the moving image content item A has the greatest difference as a result of calculation of target rates and the differential rates and the bit rate of the moving image content item A is increased by 2 Mbps, the band of the network 10 may have no room.

Accordingly, the client terminal 100 can select moving image content that changes the bit rate such that the variation in the sum of the bit rates is small. In the above example, even when the moving image content item A has the greatest difference as a result of calculation of target rates and differential rates, the client terminal 100 may increase the bit rate of the moving image content item B instead of the bit rate of the moving image content item A.

### Modification Example of Client Terminal

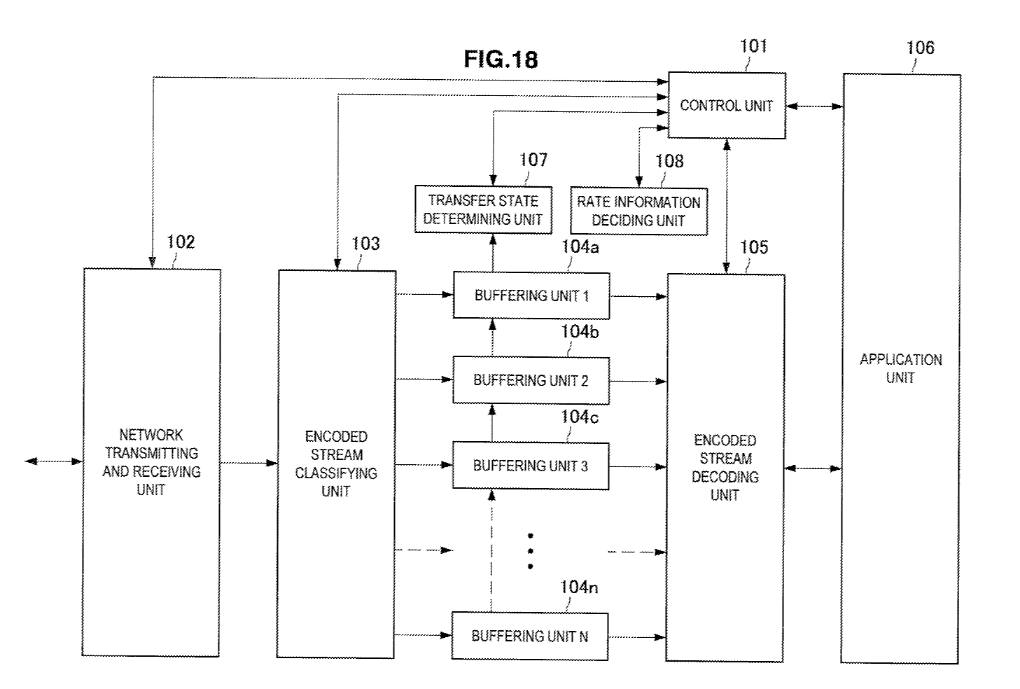

FIG. 18 shows a modification example of the client terminal 100 according to an embodiment of the present disclosure. The client terminal 100 shown in FIG. 18 is the client terminal 100 shown in FIG. 5 to which an encoded stream decoding unit 105 and an application unit 106 are added.

The encoded stream decoding unit 105 extracts encoded streams held in the content buffering units 104a, 104b, 104c, . . . , 104n under control of the control unit 101 and decodes the extracted encoded streams. By extracting and decoding the encoded streams, the encoded stream decoding unit 105 can output moving image content to the application unit 106.

The application unit 106 executes a process related to the moving image content output from the encoded stream decoding unit 105 under control of the control unit 101. Examples of processes executed by the application unit 106 include composite and reproduction of the moving image content output from the encoded stream decoding unit 105 and transmission of the moving image content output from the encoded stream decoding unit 105 to another device.

With the configuration shown in FIG. 18, the client terminal 100 can reproduce moving image content effectively and prevent wasteful consumption of the band of the network.

### 2. Conclusion

As described above, according to an embodiment of the present disclosure, it is possible to provide the client terminal 100 that receives a plurality of moving image content items from the moving image content servers 2 and 3 and reproduces the received plurality of moving image content items simultaneously. When receiving the plurality of moving image content items from the moving image content servers 2 and 3, the client terminal 100 according to an embodiment of the present disclosure decides an allocation ratio between bit rates of the respective moving image content items in advance.

The client terminal 100 according to an embodiment of the present disclosure changes the bit rates of the moving image content items using information on differences between target rates and actual rates of the respective moving image content items to receive the moving image content items from the moving image content servers 2 and 3. The client terminal 100 according to an embodiment of the present disclosure changes the bit rates repeatedly until there is no difference between the target rates and the actual rates of the respective moving image content items.

The client terminal 100 according to an embodiment of the present disclosure can reproduce the moving image content items effectively and prevent wasteful consumption of the band of the network. For example, by allocating a relatively high rate to moving image content having a high display resolution and a relatively low rate to moving image content having a low display resolution, the client terminal 100 according to an embodiment of the present disclosure enables effective reproduction of the content and prevention of wasteful consumption of the band of the network.

For example, by allocating different ratios according to display areas to moving image content items having the same resolution, the client terminal 100 according to an embodiment of the present disclosure can increase display quality of a specific moving image content item that is displayed in a position where a user is intended to be attracted. Further, even in an environment where the band of the network varies, the client terminal 100 according to an embodiment of the present disclosure acquires the moving image content items such that the band fits the allocation ratio.

Steps in processes executed by devices in this specification are not necessarily executed chronologically in the order described in a sequence chart or a flow chart. For example, steps in processes executed by devices may be executed in a different order from the order described in a flow chart or may be executed in parallel.

Further, a computer program can be created which causes hardware such as a CPU, ROM, or RAM, incorporated in each of the devices, to function in a manner similar to that of structures in the above-described devices. Furthermore, it is possible to provide a recording medium having the computer program recorded thereon. Moreover, by configuring respective functional blocks shown in a functional block diagram as hardware, the hardware can achieve a series of processes.

Although preferred embodiments of the present disclosure are described in detail with reference to the accompanying drawings, the technical scope of the present disclosure is not limited thereto. It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An image processing device including:

a content acquiring unit configured to simultaneously acquire a plurality of content items distributed through a network; and

a bandwidth deciding unit configured to decide a band allocated to each content item acquired by the content acquiring unit, using a ratio for each content item with respect to a bandwidth to be used by all the plurality of content items acquired simultaneously.

(2) The image processing device according to (1), wherein the bandwidth deciding unit decides the band allocated to each content item using a display area ratio of each of content item when the plurality of content items acquired by the content acquiring unit are displayed on one screen.

(3) The image processing device according to (1) or (2), further including:

a bandwidth measuring unit configured to measure an actually acquired bandwidth of the content items acquired by the content acquiring unit,

wherein the bandwidth deciding unit decides a band allocated to each content item in a manner that the acquired bandwidth measured by the bandwidth measuring unit is satisfied.

(4) The image processing device according to (3), wherein the bandwidth deciding unit obtains a difference between the actually acquired bandwidth for each content item and a target bandwidth calculated based on the ratio, and changes a bandwidth of the content item having a greatest difference.

(5) The image processing device according to (4),

wherein the bandwidth measuring unit determines whether there is a flow-in rate that is higher than or equal to a bandwidth that is designated for each content item in advance, among flow-in rates of the plurality of content items, for a predetermined period of time, and

wherein, when the flow-in rate that is higher than or equal to the bandwidth that is designated for each content item in advance exists, among the flow-in rates of the plurality of content items, for a predetermined period of time, the bandwidth deciding unit replaces the bandwidth of the content item having the greatest difference by a higher bandwidth.

(6) The image processing device according to (4),

wherein the bandwidth measuring unit determines whether there is a flow-in rate that is lower than a bandwidth that is designated for each content item in advance, among flow-in rates of the plurality of content items, for a predetermined period of time, and

wherein, when the flow-in rate that is lower than the bandwidth that is designated for each content item in advance exists, among the flow-in rates of the plurality of content items, for a predetermined period of time, the bandwidth deciding unit replaces the bandwidth of the content item having the greatest difference by a lower bandwidth.

(7) The image processing device according to any one of (1) to (6), wherein the bandwidth deciding unit decides the bandwidth allocated to each content item, by selecting one of the plurality of bandwidths prepared for a same content item.

(8) The image processing device according to any one of (1) to (7), further including:

a content combining unit configured to combine the plurality of content items acquired by the content acquiring unit before decoding.

(9) An image processing method including:

acquiring a plurality of content items simultaneously, the plurality of content items being distributed through a network; and

deciding a band allocated to each content item acquired in the acquiring step, using a ratio for each content item with respect to a bandwidth to be used by all the plurality of content items acquired simultaneously.

(10) A computer program causing a computer to execute:

acquiring a plurality of content items simultaneously, the plurality of content items being distributed through a network; and

deciding a band allocated to each content item acquired in the acquiring step, using a ratio for each content item with respect to a bandwidth to be used by all the plurality of content items acquired simultaneously.

What is claimed is:

1. An image processing device comprising:
a content acquiring unit configured to simultaneously acquire a plurality of content items distributed through a network; and
a bandwidth deciding unit configured to decide a band allocated to each content item acquired by the content acquiring unit, using a ratio for each content item with respect to a bandwidth to be used by all the plurality of content items acquired simultaneously.

2. The image processing device according to claim 1, wherein the bandwidth deciding unit decides the band allocated to each content item using a display area ratio of each of content item when the plurality of content items acquired by the content acquiring unit are displayed on one screen.

3. The image processing device according to claim 1, further comprising:
a bandwidth measuring unit configured to measure an actually acquired bandwidth of the content items acquired by the content acquiring unit,
wherein the bandwidth deciding unit decides a band allocated to each content item in a manner that the acquired bandwidth measured by the bandwidth measuring unit is satisfied.

4. The image processing device according to claim 3, wherein the bandwidth deciding unit obtains a difference between the actually acquired bandwidth for each content item and a target bandwidth calculated based on the ratio, and changes a bandwidth of the content item having a greatest difference.

5. The image processing device according to claim 4,
wherein the bandwidth measuring unit determines whether there is a flow-in rate that is higher than or equal to a bandwidth that is designated for each content item in advance, among flow-in rates of the plurality of content items, for a predetermined period of time, and
wherein, when the flow-in rate that is higher than or equal to the bandwidth that is designated for each content item in advance exists, among the flow-in rates of the plurality of content items, for a predetermined period of time, the bandwidth deciding unit replaces the bandwidth of the content item having the greatest difference by a higher bandwidth.

6. The image processing device according to claim 4,
wherein the bandwidth measuring unit determines whether there is a flow-in rate that is lower than a bandwidth that is designated for each content item in advance, among flow-in rates of the plurality of content items, for a predetermined period of time, and
wherein, when the flow-in rate that is lower than the bandwidth that is designated for each content item in advance exists, among the flow-in rates of the plurality of content items, for a predetermined period of time, the bandwidth deciding unit replaces the bandwidth of the content item having the greatest difference by a lower bandwidth.

7. The image processing device according to claim 1, wherein the bandwidth deciding unit decides the bandwidth allocated to each content item, by selecting one of the plurality of bandwidths prepared for a same content item.

8. The image processing device according to claim 1, further comprising:
a content combining unit configured to combine the plurality of content items acquired by the content acquiring unit before decoding.

9. An image processing method comprising:
acquiring a plurality of content items simultaneously, the plurality of content items being distributed through a network; and
deciding a bandwidth allocated to each content item acquired in the acquiring step, using a ratio for each content item with respect to a bandwidth to be used by all the plurality of content items acquired simultaneously.

10. A computer program causing a computer to execute:
acquiring a plurality of content items simultaneously, the plurality of content items being distributed through a network; and
deciding a bandwidth allocated to each content item acquired in the acquiring step, using a ratio for each content item with respect to a bandwidth to be used by all the plurality of content items acquired simultaneously.
